(19) United States
(12) Patent Application Publication
(10) Pub. No.: US 2014/0347021 A1
(43) Pub. Date: Nov. 27, 2014

(54) SAMPLING NEGATIVE COIL CURRENT IN A SWITCHING POWER CONVERTER AND METHOD THEREOF

(71) Applicants: ALEXANDER MEDNIK, CAMPBELL, CA (US); MARC TAN, SUNNYVALE, CA (US); SIMON KRUGLY, SUNNYVALE, CA (US)

(72) Inventors: ALEXANDER MEDNIK, CAMPBELL, CA (US); MARC TAN, SUNNYVALE, CA (US); SIMON KRUGLY, SUNNYVALE, CA (US)

(21) Appl. No.: 14/258,992

(22) Filed: Apr. 22, 2014

Related U.S. Application Data
(60) Provisional application No. 61/826,398, filed on May 22, 2013.

(51) Int. Cl. H02M 3/156

(52) U.S. Cl. CPC H02M 3/156
USPC 323/235

(57) ABSTRACT

An electronic circuit and method for sampling negative coil current in a power converter includes a zero crossing detector and a sample-and-hold circuit. A switch determines whether a charging or discharging current is flowing through a coil.

### CROSS-REFERENCE TO RELATED APPLICATION(S)

This application claims priority to U.S. Provisional Application, 61/826,398 filed on May 22, 2013 by the same inventors as the present application, which is incorporated by reference.

### BACKGROUND OF THE INVENTION

The present invention relates generally to power supplies, and, more specifically, to peak-current controlled switching power converter and method which allows for controlling output current of the power converter by monitoring peak current in a power switch. Furthermore, the present invention relates to zero-voltage switching power converters. And even more specifically, the present invention relates to improving current control accuracy in peak-current control of zero-voltage switching power converter.

Zero-voltage switching is a method of eliminating switching power losses in a switching power converter by turning a power switch on or off at zero volts across it.

Peak -current control, a scheme in which the output of a switch-mode power supply (SMPS) is controlled by choice of the peak current in a switching transistor, finds wide applications due to its ease of implementation, fast transient response and inherent stability. One simple example of peak-current control can be applied to a zero-voltage switching converter of a buck type operating near boundary-conduction mode. The term Boundary Conduction Model (BCM) is typically referred to a mode of operation of a switching power converter, were charging cycle of an inductive element begins immediately upon discharging it to zero current.

In the BCM buck converter, peak current in the switching transistor is representative of approximately double of its output current. However, in a zero-voltage switching buck converter, a negative current swing develops in the inductor due to resonant switching transitions and rectifier diode reverse recovery effects. In the presence of this negative current, controlling peak current produces an error with respect to average output current. This error affects accuracy of the current control loop and diminishes benefits of the peak-current control method.

Therefore, it would be desirable to provide a system and method that overcomes the above problems.

In FIG. 1, a prior art LED driver 100 of a BCM buck type powering, a plurality of LEDs 200 is illustrated. The driver 100 includes an input voltage source 101, a control switch 102, a rectifier diode 104, an output filter inductor 103, and an output filter capacitor 120. The driver also includes a control circuit. consisting of a current sense resistor 105, a comparator 106 with a reference voltage REF, a zero-current detector circuit 107, and a pulse width modulation PWM) flip-flop 108. In operation, the switch 102 is activated when a zero current condition is detected in the inductor 101 The switch 102 is switched off when the current sense signal at the resistor 105 meets the reference voltage REF.

In FIG. 2, a waveform 201 of current in the inductor 103 of the prior art LED driver is illustrated. An average current value of the waveform 201 equals the DC current in the plurality of LEDs 200. The approximate average of the waveform 201 equals half of the voltage at REF divided by the resistance of 105. An error results from the negative swing of the waveform 201.

### BRIEF SUMMARY OF THE INVENTION

In the various embodiments of the present disclosure, a boundary condition mode power converter is provided having a zero crossing detector having an input node and an output node, a sample and hold circuit coupled to the output node of the zero crossing detector, a switch coupled to the input node of the zero crossing detector, a coil coupled to the switch and to the input node of the zero crossing detector, and a current sense element coupled to the switch and to the sample and hold circuit.

In another embodiment, a buck converter has a zero crossing detector having an input node and an output node, a sample and hold circuit coupled to the output node of the zero crossing detector, a switch coupled to the input node of the zero crossing detector, a coil coupled to the switch and to the input node of the zero crossing detector, a current sense element coupled to the switch and to the sample and hold circuit, and a load coupled to the zero crossing detector and to the coil.

A method for sensing current in a zero-voltage switching power converter, comprises providing an input voltage at a input node of a zero crossing detector, providing an output voltage of the zero crossing detector wherein the output voltage rises contemporaneously with the input voltage, reaching substantially zero, providing the output voltage to a sample-and-hold circuit, and providing a current sense voltage to the sample-and-hold circuit.

This brief summary describes the general nature of the disclosure so that it may be readily understood. A more complete understanding of the disclosure, including its many advantages, can be obtained by reference to the following brief description of the drawings, the drawings themselves, the detailed description of the various embodiments and the claims.

### BRIEF DESCRIPTION OF THE DRAWINGS

FIG. 1 is a prior art circuit diagram;

FIG. 2 is a current time form related to the prior art circuit of FIG. 1;

FIG. 3 is a circuit diagram according to one embodiment of the present disclosure;

FIG. 4 is a circuit diagram of a zero crossing detector (ZCD) according to one embodiment of the present disclosure;

FIG. 5 is a current wave form according to one embodiment of the present disclosure; and

FIG. 6 is an alternative circuit diagram according to an embodiment of he present disclosure.

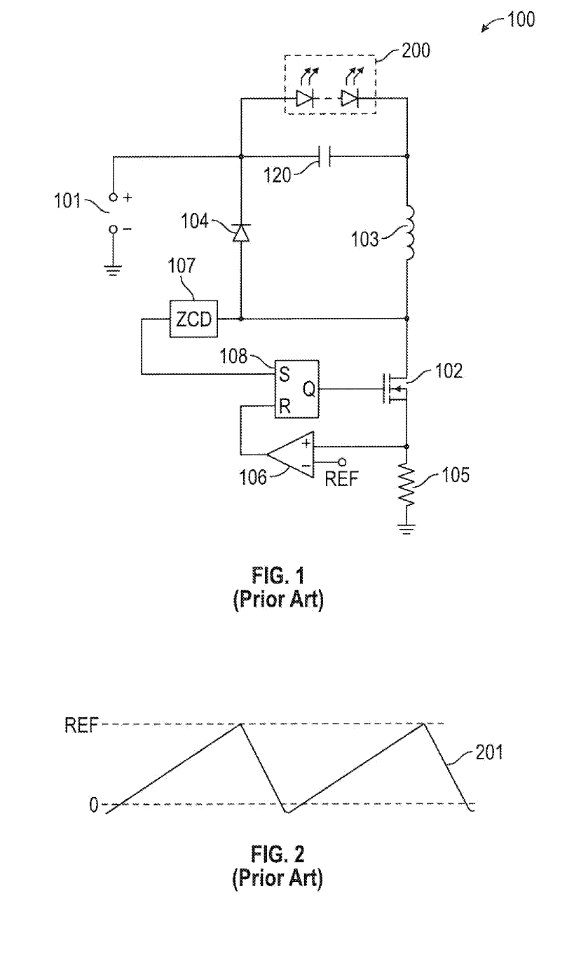

The following detailed description describes the present embodiments with reference to the drawings. In the drawings, reference numerals label elements of the present embodiments, wherein like numerals indicate like elements. These reference numerals are reproduced below in connection with the discussion of the corresponding figures.

### DETAILED DESCRIPTION

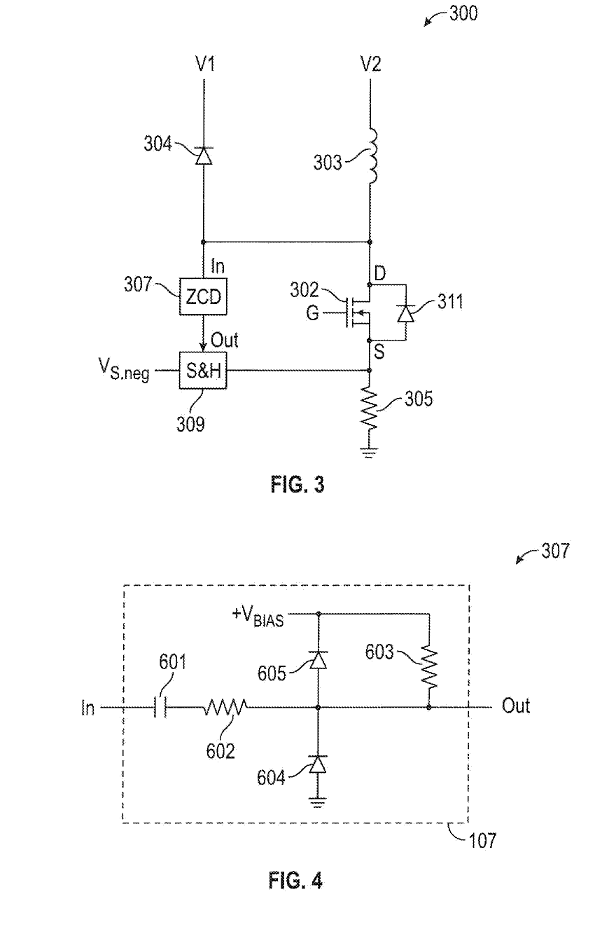

Referring to FIG. 3, power converter topology 300 in accordance with an embodiment of the present disclosure is shown operating near BCM with zero-voltage switching. The power converter 300 comprises a switch 302, a coil 303 (which may be an inductor), a diode 304, a current sensing resistor 305, a zero crossing detector (ZCD) 307, a sample-and-hold circuit 309 and a diode 311.

The switch 302 may be a transistor, such as a MOSFET. As illustrated in FIG. 3, the switch 302 has drain (D), gate (G) and source (S) terminals. When the gate is biased, the switch 302 is closed and conducting current. When the gate is unbiased, the switch 302 is open and in a non-conducting mode.

The diode 311 may represent an intrinsic body diode of the switch 302, i.e. an anti-parallel diode. As illustrated in FIG. 3, the diode 311 has an anode which may be connected to the source terminal of the switch 302 and a cathode, which may be connected to the drain terminal of switch 302.

The sample-and-hold circuit 309 is illustrated to sample negative current sense voltage at the resistor 305 when a zero-voltage condition is detected across the switch 302 by the ZCD circuit 307. The sample-and-hold circuit 309 outputs sampled negative current sense voltage V_{Sneg}. A cathode of the diode 304 may be connected to voltage V1, i.e. the input voltage for a load in the case of a buck converter topology. An anode of the diode 304 may be connected to the drain terminal D. An input node (labeled “IN”) of the ZCD circuit 307 may be connected to the drain D. An output node (labeled “OUT”) of the ZCD 307 may be connected to the sample-and-hold circuit 309. The sample-and-hold circuit 309 may also be connected to the switch 302 and to the current sensing resistor 305.

One terminal of the coil 303 may be connected to voltage V2, i.e. an output voltage of the load in the case of a buck converter topology. The other terminal of the coil 303 may be connected to the drain terminal D. The input node of the ZCD circuit 307 may be connected to the drain terminal D. The coil may charge when the switch 302 is conductive and discharge when the switch 302 is non-conductive.

FIG. 4 illustrates one embodiment of the ZCD circuit 307 according to the present disclosure. The ZCD circuit has input node IN and output node OUT. Input node IN may be connected to differentiator capacitor 601. An input voltage to the ZCD 307 may represent a voltage at a drain terminal D of the transistor 302. Resistor 602 may be added to limit the current through capacitor 601. A pull-up element or resistor 603 may be connected to V_{BIAS}. Diodes 604 and 605, i.e. diode clamp, may be included to limit voltage at the output node OUT between the approximately potential of V_{BIAS} and the approximately ground potential.

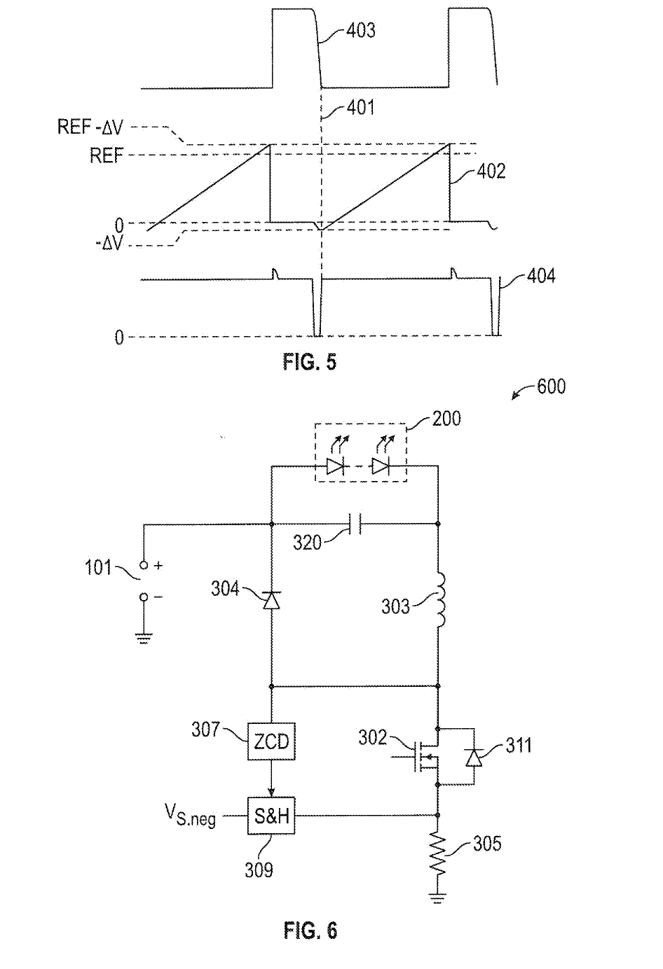

FIG. 5 illustrates operation of the power converter 300 combined with the ZCD circuit 307. Waveform 402 represents current sense voltage at the resistor 305. Waveform 403 represents voltage at a drain terminal D of the switch 302. Time moment 401 designates when voltage at the switch 302 drops to zero and the diode 311 becomes forward-biased. While the switch 302 or the diode 311 are conductive, the current sense voltage at the resistor 305 reflects the current in the coil 303. Current through the coil 303 may reverse direction as a function of reverse recovery of the diode 304, as well as parasitic capacitance present at the drain terminal D. This parasitic capacitance may be contributed by output capacitance of the switch 3 05, junction capacitance of the diode 304, inter-winding capacitance of the coil 303, and stray capacitance of wiring connecting these elements.

The diode 3 1 1 may become forward-biased as a result of the current in the coil 303 reversing its direction. As the diode 311 becomes forward-biased, complete current of the coil 303 becomes available for measuring at the sense resistor 3 05. A waveform 404 represents voltage at the output node OUT of the ZCD circuit 307. Time moment 401 is detected as a rising edge of the voltage 404, generated by the pull-up resistor 603 once current in the differentiator capacitor 601 drops below the pull-up current of the resistor 603. This moment may occurs following the diode 3 11 conduction. The sample-and-hold circuit 309 samples the corresponding negative voltage drop across the sense resistor 305 at the time moment 401. That is, when the MOSFET 302 body diode conducts, negative current developed in the coil 303 appears at the current sense resistor 305. At this moment, the corresponding negative current sense voltage V_{Sneg} may be sampled at the resistor 305.

Referring to FIG. 6, a buck converter 600 representing one embodiment of the power converter 300 is illustrated. In addition to the elements of the power converter 300 described above in FIG. 3, the buck converter 600 further comprises input voltage source 101, the plurality of LEDs 200 which may be connected to diode 304 and to inductor 303. An output filter capacitor 320 may also be included. In the buck converter 600, average current of the coil 303 is substantially equal to the current of the plurality of LEDs 200. Therefore, the corresponding negative current sense voltage V_{Sneg} can be used for the purpose of accurate control over the current in the plurality of LEDs 200.

Although the present disclosure has been described with reference to specific embodiments, these embodiments are illustrative only and not limiting. Many other applications and embodiments of the present disclosure will be apparent in light of this disclosure and the following claims. References throughout this specification to “one embodiment” or “an embodiment” means that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics being referred to may be combined as suitable in one or more embodiments of the disclosure, as will be recognized by those of ordinary skill in the art.

What is claimed is:

1. A method for sampling current in a zero-voltage switching converter, comprising:
providing an inductor which develops a negative current when discharging;
providing a switch baying an anti-parallel diode coupled to the inductor; and
sampling the negative inductor current when the anti-parallel diode conducts.

2. The method of claim 1 wherein the converter is of a buck type.

3. The method of claim 1 wherein the switch is a MOSFET.

4. The method of claim 3 wherein the anti-parallel diode is an intrinsic body diode of the MOSFET.

5. The method of claim 1 wherein the converter develops a peak current.

6. The method of claim 5 wherein the sampled negative inductor current may be used to correct the peak current.

7. The method of claim 1 further comprising providing a current sense resistor coupled to the switch wherein the negative inductor current may be sampled at the current sense resistor.

8. The method of claim 7 further comprising holding the negative inductor current value sampled at the current sense resistor.

9. A method for sampling current in a converter, comprising:
providing a coil which develops a negative current when discharging;
providing a zero crossing detector having an input node coupled to the coil and having an output node; and
sampling the negative coil current upon a signal at the output node.

10. The method of claim 9 further comprising a switch coupled to the coil.

11. The method of claim 10 wherein the switch is a MOSFET having a source terminal and a drain terminal.

12. The method of claim 9 wherein the converter is a buck type converter.

13. The method of claim 11 wherein the drain terminal is connected to the input node.

14. The method of claim 9 wherein the coil is an inductor.

15. The method of claim 9 further comprising coupling the output node to a sample and hold circuit.

16. The method of claim 9, wherein the zero crossing detector further comprising:
coupling a capacitor to the input node and the output node; and
coupling a pull-up element to the output node.

17. The method of claim 16 wherein the pull-up element is a resistor coupled to a positive bias voltage source.

18. The method of claim 16, wherein the zero crossing detector is further comprising coupling a voltage-limiting element to the output node.

19. The method of claim 18 wherein the voltage-limiting element is a diode damp.

20. The method of claim 16 further comprising coupling a resistor in series with the capacitor for limiting current through the capacitor.

21. A method for sampling current in a power converter, comprising:
providing an inductor which has a negative current when discharging;
providing a switch having an anti-parallel diode coupled to the inductor; and
sampling the negative inductor current when the anti-parallel diode conducts.

22. The method of claim 21 wherein the converter develops a peak current.

23. The method of claim 22 wherein the sampled negative inductor current is used to correct the peak current.

24. The method of claim 21 further comprising providing a current sense resistor coupled to the switch wherein the negative inductor current may be sampled at the current sense resistor.
